(19) United States
(12) Patent Application Publication
(10) Pub. No.: US 2026/0018058 A1
(43) Pub. Date: Jan. 15, 2026

(54) EMERGENCY REPORT SYSTEM AND VEHICLE

(71) Applicant: SUBARU CORPORATION, Tokyo (JP)

(72) Inventors: Tomoyuki KITAMURA, Tokyo (JP); Yusuke OHAMA, Tokyo (JP)

(21) Appl. No.: 19/235,778

(22) Filed: Jun. 12, 2025

(30) Foreign Application Priority Data
Jul. 9, 2024 (JP) 2024-110494

(51) Int. Cl. G08G 1/16; G08G 1/09; H04W 4/90

(52) U.S. Cl. CPC G08G 1/164; G08G 1/091; G08G 1/162; H04W 4/90

(57) ABSTRACT

An emergency report system is applicable to a vehicle configured to establish vehicle-to-vehicle communication and includes a processor and a communicator. The communicator is configured to perform transmission and reception of report information. The processor is configured to, when the communicator starts receiving the report information, determine whether the vehicle is stoppable, and when determining that the vehicle is stoppable, execute vehicle stop control of stopping the vehicle and keeping the vehicle stopped until the reception of the report information is completed.

### CROSS-REFERENCE TO RELATED APPLICATIONS

The present application claims priority from Japanese Patent Application No. 2024-110494 filed on Jul. 9, 2024, the entire contents of which are hereby incorporated by reference.

### BACKGROUND

The disclosure relates to an emergency report system and a vehicle.

According to an existing technique disclosed in Japanese Unexamined Patent Application Publication No. 2007-065838, for example, when a vehicle is present outside a network communication range and is thus not capable of issuing an emergency report via wireless communication upon an emergency event such as an accident or a bad physical condition of an occupant in the vehicle, an emergency report system in the vehicle transmits report information to another vehicle present within the network communication range via vehicle-to-vehicle communication and causes the other vehicle to issue the emergency report.

### SUMMARY

An aspect of the disclosure provides an emergency report system to be applied to a vehicle configured to establish vehicle-to-vehicle communication. The emergency report system includes a processor and a communicator. The communicator is configured to perform transmission and reception of report information. The vehicle includes a first vehicle configured to receive the report information. The processor in the first vehicle is configured to, when the communicator in the first vehicle starts receiving the report information, determine whether the first vehicle is stoppable, and when determining that the first vehicle is stoppable, execute vehicle stop control of stopping the first vehicle and keeping the first vehicle stopped until the reception of the report information is completed.

An aspect of the disclosure provides a vehicle including an emergency report system. The emergency report system includes a processor and a communicator. The communicator is configured to perform transmission and reception of report information. The vehicle includes a first vehicle configured to receive the report information. The processor in the first vehicle is configured to, when the communicator in the first vehicle starts receiving the report information, determine whether the first vehicle is stoppable, and when determining that the first vehicle is stoppable, execute vehicle stop control of stopping the first vehicle and keeping the first vehicle stopped until the reception of the report information is completed.

### BRIEF DESCRIPTION OF THE DRAWINGS

The accompanying drawings are included to provide a further understanding of the disclosure and are incorporated in and constitute a part of this specification. The drawings illustrate example embodiments and, together with the specification, serve to explain the principles of the disclosure.

FIG. 1 is a block diagram illustrating an exemplary configuration of a vehicle including an emergency report system according to one example embodiment of the disclosure.

FIG. 2 is a diagram illustrating communication between a report center and vehicles each including the emergency report system illustrated in FIG. 1.

FIG. 3 is a flowchart of control processing to be performed by the emergency report system illustrated in FIG. 1 in a vehicle having caused an emergency event.

FIG. 4 is a flowchart of a vehicle-to-vehicle bucket-brigade process to be performed by the emergency report system illustrated in FIG. 1.

FIG. 5 is a flowchart of control processing to be performed by the emergency report system in a vehicle to receive report information.

FIG. 6 is a flowchart of vehicle non-stop control to be performed by the emergency report system illustrated in FIG. 1.

### DETAILED DESCRIPTION

When traveling in poor communication environments with many obstacles, such as mountain roads or bad-condition national roads, a vehicle can fail to complete transmitting report information to a relay vehicle via vehicle-to-vehicle (V2V) communication if the relay vehicle runs away out of the range of the V2V communication at a high speed.

Upon an emergency event in a low-traffic place, it is necessary for the vehicle to surely transmit the report information to the relay vehicle communicable with the vehicle via the V2V communication. To surely transmit the report information to the relay vehicle, it is desired to keep the relay vehicle stopped during the V2V communication.

It is desirable to provide an emergency report system and a vehicle each making it possible to improve effectiveness of an emergency report by urging a relay vehicle to keep stopping while report information is transmitted to the relay vehicle via V2V communication and issuing an emergency report via the relay vehicle.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

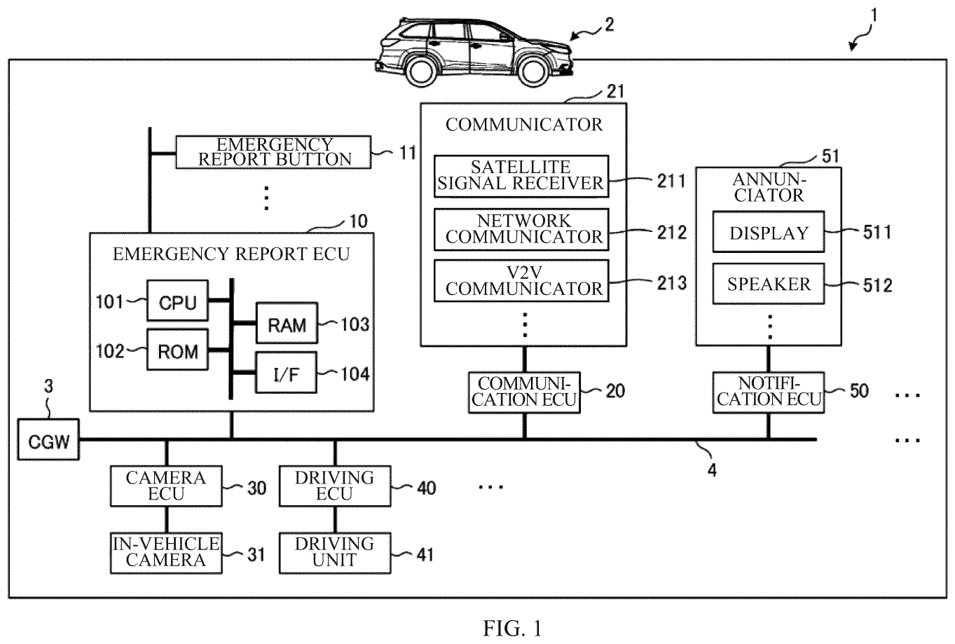

A description will be given, with reference to FIG. 1, of electric control units (ECUs) and control target devices in an emergency report system 1 according to an example embodiment of the disclosure. The emergency report system 1 according to the present example embodiment may include the control target devices mounted in a vehicle 2 and the ECUs that control the control target devices. In one embodiment, the ECUs may serve as a “processor”. The control target devices and the ECUs may be communicably coupled to each other via an in-vehicle network 4, such as a controller area network (CAN) or a local interconnect network (LIN), and a relay device, such as a central gateway (CGW) 3. In some embodiments, the CGW 3 may not be provided, and the ECUs may be configured to communicate with each other directly or indirectly.

In the emergency report system 1, each ECU may output data on an operation state of the control target device to the in-vehicle network 4. Further, each ECU may control an operation of the control target device, based on the data received from the other ECUs via the in-vehicle network 4.

Each ECU may include a processor, such as a central processing unit (CPU) or a micro processing unit (MPU), and cause the processor to execute various kinds of processing. Further, each ECU may include a volatile memory, such as a random-access memory (RAM), that temporarily processes the data to be used by the processor, or a non-volatile memory, such as a read only memory (ROM), that stores data such as a program to be executed by the processor or another device. In some embodiments, a part or the entirety of the operation to be executed by each ECU may be implemented by hardware, such as an application specific integrated circuit (ASIC), a field-programmable gate array (FPGA), or a graphics processing unit (GPU).

In FIG. 1, some of the ECUs in the emergency report system 1, including an emergency report ECU 10, a communication ECU 20, a camera ECU 30, a driving ECU 40, and a notification ECU 50, are illustrated, and illustration of the other ECUs is omitted. Further, in FIG. 1, some of the control target devices and switches, including an emergency report button 11, a communicator 21, an in-vehicle camera 31, a driving unit 41, and an annunciator 51, are illustrated, and illustration of the other control target devices or switches is omitted. In the present example embodiment, illustration and detailed description of ECUs and control target devices not relevant to the functionality and operation of the emergency report system 1 are omitted even if the control target devices or switches are included in the emergency report system 1.

As illustrated in FIG. 1, the emergency report ECU 10 may include a CPU 101, a ROM 102, a RAM 103, and an interface 104. The emergency report ECU 10 may cause the CPU 101 to execute various kinds of processing, based on programs held in the ROM 102, to thereby execute control processing in the emergency report system 1. The ROM 102 provided as a non-volatile memory may hold: data received from the other ECUs via the in-vehicle network 4; programs to be used in executing processing in the emergency report system 1, based on an input operation on a device such as the emergency report button 11 to be described later; and various kinds of data necessary to execute these programs.

The RAM 103 provided as a volatile memory may be used as a work area for the CPU 101 performing various kinds of processing. Various kinds of data outputted from each ECU may be temporarily recorded in the RAM 103, as needed.

The interface 104 may control input or output of various kinds of data and control signals to be used in the emergency report ECU 10. In some embodiments, the interface 104 may receive data outputted from each ECU to the in-vehicle network 4, and data outputted from the emergency report button 11 to be described later. Further, the interface 104 may output a control signal generated by the CPU 101 to a destination appropriate to the content of the control.

Thereafter, the CPU 101 may read the program held in the ROM 102 and develop the program in a memory such as the RAM 103, to thereby execute the control processing in the emergency report system 1.

Although not illustrated in the drawings and not described in the following description, each of the communication ECU 20, the camera ECU 30, the driving ECU 40, and the notification ECU 50 may also include a CPU, a ROM, a RAM, and an interface, like the emergency report ECU 10, and control the control target device by causing the CPU to perform various kinds of processing, based on programs held in the ROM.

In some embodiments, the emergency report button 11 may be a push button switch provided in a vehicle compartment of the vehicle 2, or a liquid crystal display button displayed on a display, such as a center information display (CID), and receiving a touch operation. The emergency report button 11 may be operated by an occupant of the vehicle 2 when the occupant comes into a bad physical condition or is involved in an accident, which causes report information to be sent to a report center H. This allows the occupant of the vehicle 2 to easily send the emergency report to the report center H and ask for rescue, without making a conversation or another action.

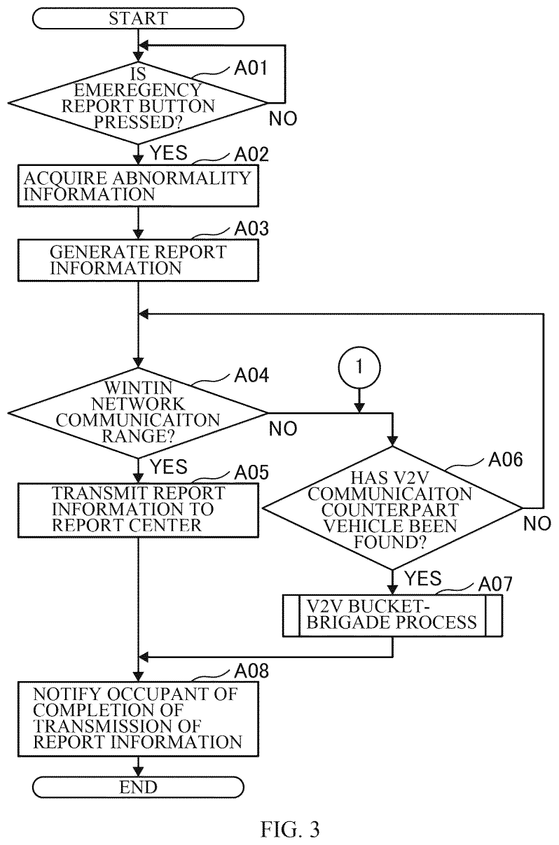

Upon detecting the operation on the emergency report button 11, the emergency report ECU 10 may acquire data from the communication ECU 20 or the camera ECU 30 via the in-vehicle network 4, and generate the report information, based on the acquired data. The generation of the report information and other control processing will be described later with reference to FIG. 3.

The communication ECU 20 may control the communicator 21 to establish V2V communication or communication via a network L. The communicator 21 may include at least a satellite signal receiver 211, a network communicator 212, and a V2V communicator 213. The satellite signal receiver 211 may receive electric waves from artificial satellites on a predetermined time basis. In some embodiments, the satellite signal receiver 211 may identify a current position of the vehicle 2, based on electric waves received from a global navigation satellite system (GNSS). The network communicator 212 may transmit and receive information via the network L, as long as the vehicle 2 is present within a communication range of the network L. The network communicator 212 may be configured to communicate with the report center H via the network L to transmit the report information to the report center H. The V2V communicator 213 may be configured to establish the V2V communication with another vehicle 2 having a communication range overlapping the communication range of the vehicle 2.

The camera ECU 30 may control the in-vehicle camera 31. In some embodiments, the in-vehicle camera 31 may include at least an unillustrated in-vehicle camera and an unillustrated outside-vehicle camera. The in-vehicle camera may be included in a driver monitoring system (DMS) that captures an image of a driver who drives the vehicle 2, and may capture an image of an inside of the vehicle 2. The outside-vehicle camera may be used as a drive recorder, and may capture an image of an outside of the vehicle 2. The in-vehicle camera and the outside-vehicle camera may be configured to capture a static image and a moving image. The camera ECU 30 may output the static image and the moving image captured by the in-vehicle camera 31 to the in-vehicle network 4.

The driving ECU 40 may control the driving unit 41. In some embodiments, the driving unit 41 may include an unillustrated shift lever, an unillustrated accelerator pedal, an unillustrated brake pedal, and a drive system relevant to the travel of the vehicle 2. The driving ECU 40 may control the travel of the vehicle 2 by controlling the driving unit 41 including these components. The driving ECU 40 may output traveling information on a traveling state of the vehicle 2 to the in-vehicle network 4. The traveling state of the vehicle 2 may be based on an operation of the driving unit 41, such as an operation of the accelerator pedal, an operation of the brake pedal, or an operation of the shift lever.

The notification ECU 50 may control the annunciator 51 to issue a notification to the occupant of the vehicle 2. The annunciator 51 may include at least a display 511 and a speaker 512. In some embodiments, the display 511 may be a CID or an instrument panel. In issuing a notification to the occupant of the vehicle 2, the annunciator 51 may cause the display 511 to display a content of the notification. The speaker 512 may be configured to perform audio output. In issuing a notification to the occupant of the vehicle 2, the speaker 512 may perform audio output indicating the content of the notification.

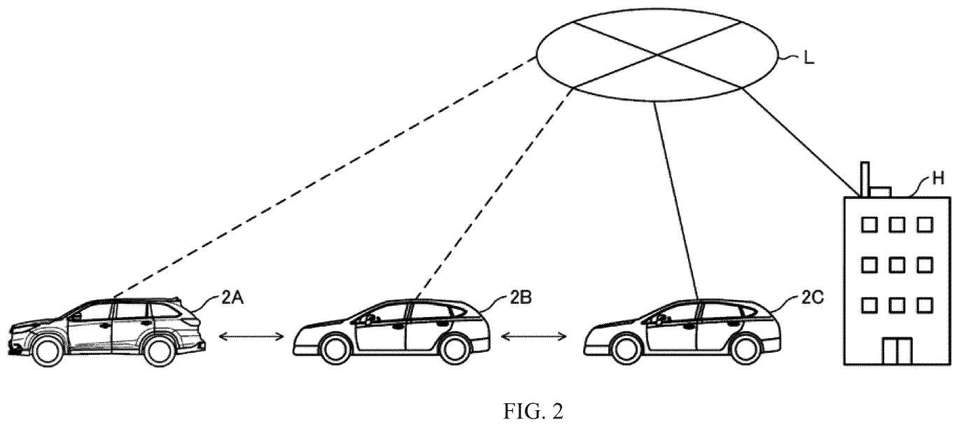

Next, a description will be given, with reference to FIG. 2, of communication between the report center H and vehicles 2 each including the emergency report system 1. The report information may be transmitted from the vehicles 2 to the report center H via the network L. The report center H may transmit the received report information to an emergency service facility, such as an emergency hospital, a police station, or a fire station to ask for the dispatch of rescue crews to the emergency site. In one example illustrated in FIG. 2, the vehicle 2 having caused an emergency event may correspond to an abnormal vehicle 2A, the vehicle 2 to receive the report information from the abnormal vehicle 2A and relay the report information may correspond to a relay vehicle 2B, and the vehicle 2 to receive the report information from the relay vehicle 2B and relay the report information may correspond to a relay vehicle 2C. Each of the vehicles 2 may include the emergency report system 1.

In FIG. 2, lines coupling the network L to the respective vehicles 2 and the report center H indicate communication coupling or decoupling states of the network L with respect to the respective vehicles 2 and the report center H: A solid line indicates the communication coupling state of the network L, and a dotted line indicates the communication decoupling state of the network L. In the situation illustrated in FIG. 2, the abnormal vehicle 2A and the relay vehicle 2B are not communicably coupled to the network L, whereas the relay vehicle 2C and the report center H are communicably coupled to the network L.

When the emergency report button 11 in the abnormal vehicle 2A is operated in the situation illustrated in FIG. 2, the abnormal vehicle 2A may try to transmit the report information to the report center H via the network L. However, since the abnormal vehicle 2A is present out of the communication range of the network L, it is difficult for the abnormal vehicle 2A to transmit the report information to the report center H via the network L. In this case, the abnormal vehicle 2A may establish the V2V communication with a V2V communication counterpart vehicle 2 that is a surrounding vehicle communicable with the abnormal vehicle 2A via the V2V communication, to thereby transmit the report information to the V2V communication counterpart vehicle 2. In the situation illustrated in FIG. 2, the abnormal vehicle 2A may establish the V2V communication with the relay vehicle 2B to transmit the report information to the relay vehicle 2B.

When receiving the report information from the abnormal vehicle 2A, the relay vehicle 2B may try to transmit the received report information to the report center H via the network L. However, since the relay vehicle 2B is present out of the communication range of the network L, it is difficult for the relay vehicle 2B to transmit the report information to the report center H via the network L. In this case, the relay vehicle 2B may establish the V2V communication with another V2V communication counterpart vehicle 2 that is a surrounding vehicle communicable with the relay vehicle 2B via the V2V communication, to thereby transmit the report information to the V2V communication counterpart vehicle 2. In the situation illustrated in FIG. 2, the relay vehicle 2B may establish the V2V communication with the relay vehicle 2C to transmit the report information to the relay vehicle 2C.

When receiving the report information from the relay vehicle 2B, the relay vehicle 2C may try to transmit the received report information to the report center H via the network L. Since the relay vehicle 2C is present within the communication range of the network L, it is possible for the relay vehicle 2C to transmit the report information to the report center H via the network L. In this case, the relay vehicle 2C may transmit the report information to the report center H via the network L.

In the above-described situation where it is difficult for the vehicle 2 having caused the emergency event to directly transmit the emergency report to the report center H, the V2V communication may be established to relay the report information to the V2V communication counterpart vehicle 2 that is a surrounding vehicle present within the communication range of the network L, and the V2V communication counterpart vehicle 2 may transmit the report information to the report center H.

Next, a description will be given, with reference to FIG. 3, of the control processing to be performed by the emergency report system 1 according to the present example embodiment in the vehicle 2 having caused the emergency event (hereinafter referred to as the abnormal vehicle 2A).

The emergency report ECU 10 may monitor an operation of the emergency report button 11 (Step A01). The emergency report button 11 may be operated by an occupant in the abnormal vehicle 2A when the occupant comes into a bad physical condition or is involved in a traffic accident, for example, to ask for rescue.

Upon detecting the operation on the emergency report button 11 (Step A01: YES), the emergency report ECU 10 may acquire abnormality information (Step A02). In some embodiments, the emergency report ECU 10 may acquire, as the abnormality information, information on a current position acquired by the communicator 21 upon the operation of the emergency report button 11, and the static image and moving image captured by the in-vehicle camera 31 upon the operation of the emergency report button 11. The moving image captured by the in-vehicle camera 31 may be a moving image for about 15 seconds after the operation of the emergency report button 11.

After acquiring the abnormality information, the emergency report ECU 10 may generate the report information, based on the acquired abnormality information (Step A03). The report information may include the time of the operation of the emergency report button 11, the acquired abnormality information, and, if registered, user information and appearance features of the vehicle 2. After generating the report information, the emergency report ECU 10 may transmit the report information to the communication ECU 20 via the in-vehicle network 4.

When acquiring the report information, the communication ECU 20 may determine whether the abnormal vehicle 2A is present within the communication range of the network L (Step A04). If the abnormal vehicle 2A is present within the communication range of the network L (Step A04: YES), the communication ECU 20 may transmit the generated report information from the network communicator 212 to the report center H via the network L (Step A05).

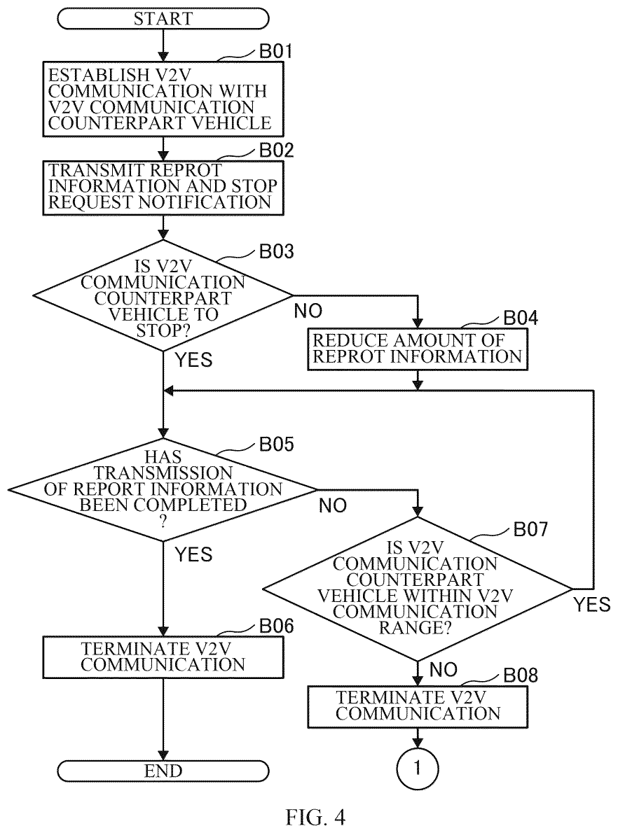

If the abnormal vehicle 2A is present out of the communication range of the network L (Step A04: NO), the communication ECU 20 may search for a V2V communication counterpart vehicle 2 that is a surrounding vehicle communicable with the abnormal vehicle 2A via the V2V communication, using the V2V communicator 213 (Step A06). If the V2V communication counterpart vehicle 2 has been found (Step A06: YES), the communication ECU 20 of the abnormal vehicle 2A may execute a V2V bucket-brigade process (Step A07). The V2V bucket-brigade process may involve transmitting the report information to the V2V communication counterpart vehicle 2 when the abnormal vehicle 2A is present out of the communication range of the network L, as illustrated in FIG. 2. The V2V bucket-brigade process will be described in detail later with reference to FIG. 4.

If the abnormal vehicle 2A runs into the communication range of the network L during the search for the V2V communication counterpart vehicle 2 (Step A06: NO and Step A04: YES), the communication ECU 20 may transmit the generated report information from the network communicator 212 to the report center H via the network L (Step A05).

When the transmission of the report information in Step A05 is completed or when the V2V bucket-brigade process in Step A07 is completed, the notification ECU 50 may notify the occupant in the abnormal vehicle 2A of the completion of the transmission of the report information (Step A08). The notification in Step A08 may be issued by displaying the notification on the display 511, outputting the notification in the form of a sound from the speaker 512, or both. The notification may indicate simply that the transmission has been completed. In some embodiments, the notification may indicate that the transmission of the report information to the report center H has been completed when to be issued after Step A05, or may indicate that the transmission of the report information to the surrounding vehicle 2 has been completed when to be issued after Step A07. In this way, the content of the notification may be changed depending on the situation. The notification in Step A08 allows the occupant in the abnormal vehicle 2A to know that the report information has been transmitted safely. This mitigates the anxiety of the occupant.

In the processing to be performed by the emergency report system 1 described above with reference to FIG. 3, the emergency report ECU 10 may acquire the abnormality information upon detecting the operation of the emergency report button 11. However, the emergency report ECU 10 may acquire the abnormality information upon detecting an emergency event, based on the image captured by the in-vehicle camera 31 provided in the abnormal vehicle 2A or other pieces of data, rather than upon detecting the operation of the emergency report button 11. In some embodiments, the emergency report ECU 10 may start acquiring the abnormality information when a bad physical condition of the occupant has been detected based on the image captured by the in-vehicle camera or when an accident has been detected based on the image captured by the outside vehicle camera or activation of an unillustrated air-bag, to thereby issue the emergency report.

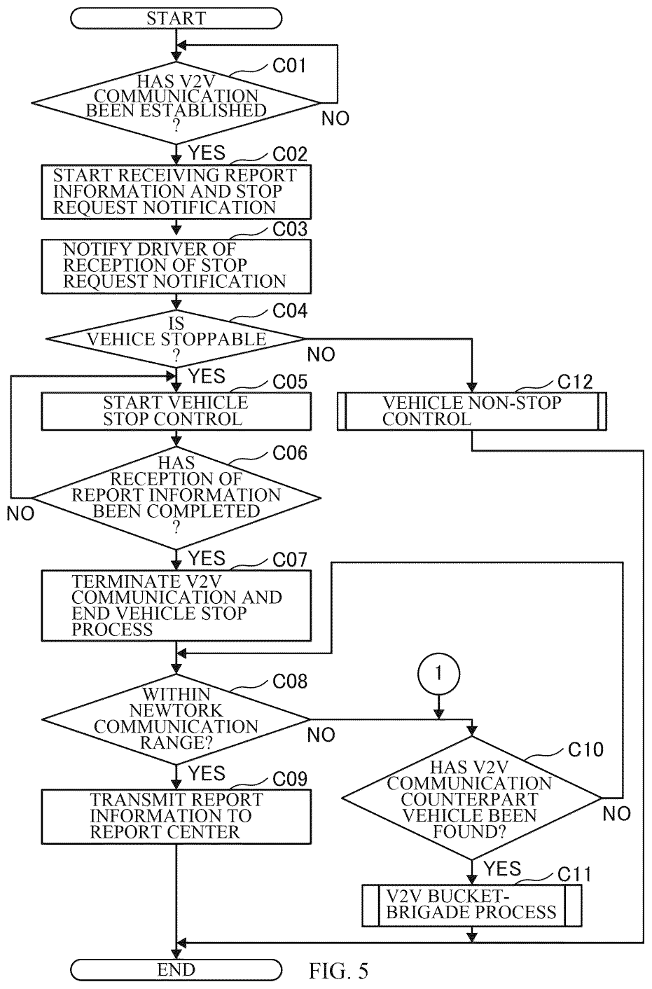

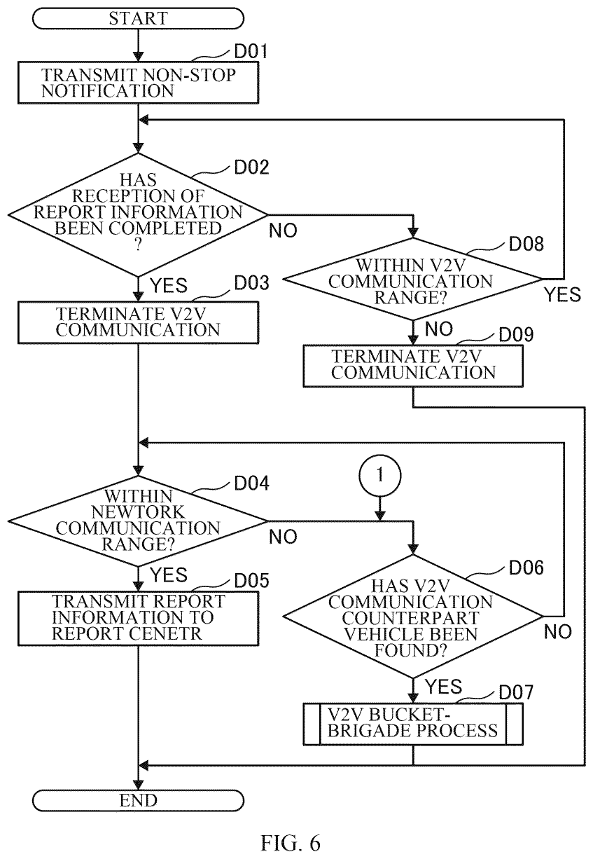

Next, a description will be given, with reference to FIG. 4, of the V2V bucket-brigade process to be performed by the emergency report system 1 according to the present example embodiment. The V2V bucket-brigade process may be executed when the V2V communication counterpart vehicle 2 has been found in Step A06 in FIG. 3, Step C10 in FIG. 5 to be described later, or Step D06 in FIG. 6 to be described later.

The communication ECU 20 may establish the V2V communication with the V2V communication counterpart vehicle 2 (e.g., the relay vehicle 2B as a V2V communication counterpart to the abnormal vehicle 2A, or the relay vehicle 2C as a V2V communication counterpart to the relay vehicle 2B in FIG. 2) found in Step A06 in FIG. 3, Step C10 in FIG. 5 to be described later, or Step D06 in FIG. 6 to be described in later (Step B01). When the V2V communication has been established, the communication ECU 20 may start transmitting the report information together with a stop request notification (Step B02).

After starting the transmission of the report information together with the stop request notification (Step B02), the communication ECU 20 may determine whether the V2V communication counterpart vehicle 2 (e.g., the relay vehicle 2B as a V2V communication counterpart to the abnormal vehicle 2A, or the relay vehicle 2C as a V2V communication counterpart to the relay vehicle 2B in FIG. 2) is to stop (Step B03). The determination as to whether the V2V communication counterpart vehicle 2 is to stop may be made based on whether a non-stop notification has been received from the V2V communication counterpart vehicle 2. The non-stop notification may be a notification to be transmitted from the vehicle 2 having received the stop request notification. The non-stop notification will be described in detail later with reference to FIG. 6. If the non-stop notification has been received and the V2V communication counterpart vehicle 2 is determined not to stop (Step B03: NO), the processing may proceed to Step B04. If the non-stop notification has not been received and the V2V communication counterpart vehicle 2 is determined to stop (Step B03: YES), the processing may proceed to Step B05. Note that the transmission of the report information to the V2V communication counterpart vehicle 2 may continue while the determination in Step B03 is made.

If the non-stop notification has been received in Step B03 and the V2V communication counterpart vehicle 2 is determined not to stop (Step B03: NO), the communication ECU 20 may reduce the amount of the report information to transmit (Step B04). In some embodiments, the communication ECU 20 may reduce the amount of the report information to transmit by excluding large-amount information, such as a moving image, from the report information to transmit. Such a reduction in the amount of the report information to transmit helps to complete the transmission of the report information at an early time before the V2V communication counterpart vehicle 2 runs away out of the V2V communication range. After the reduction in the amount of the report information is completed, the processing may proceed to Step B05. If the non-stop notification has not been received and the V2V communication counterpart vehicle 2 is determined to stop (Step B03: YES), the processing may proceed to Step B05 without reducing the amount of the report information.

When the V2V communication counterpart vehicle 2 is determined to stop (Step B03: YES) or after the report information to transmit is reduced in amount (Step B04), the communication ECU 20 may wait until the transmission of the report information is completed (Step B05). If the transmission of the report information has been completed (Step B05: YES), the communication ECU 20 may terminate the V2V communication (Step B06) and end the series of processes.

As described above, the reduction in the amount of the report information to transmit in Step B04 may be performed when the V2V communication counterpart vehicle 2 is not to stop, in order to complete the transmission of the report information before the V2V communication counterpart vehicle 2 runs away out of the V2V communication range. However, in a case where the V2V communication counterpart vehicle 2 travels at a high vehicle speed or when the V2V communication is to be established in a poor communication environment having many obstacles, the V2V communication counterpart vehicle 2 may possibly run away from the V2V communication range before the transmission of the report information is completed (Step B07: NO). In this case, the communication ECU 20 may terminate the V2V communication (Step B08), and thereafter the processing in the emergency report system 1 may return to the process to be performed before the execution of the V2V bucket-brigade process. For example, in a case where the bucket-brigade process is performed in Step A07, the processing may return to the process in Step A06 after the process in Step B08 is executed, as illustrated in FIG. 3. Likewise, in a case where the bucket-brigade process is performed in Step C11, the processing may return to the process in Step C10 after the process in Step B08 is executed, as illustrated in FIG. 5. Likewise, in a case where the bucket-brigade process is performed in Step D07, the processing may return to the process in Step D06 after the process in Step B08 is executed, as illustrated in FIG. 6.

As described above with reference to FIG. 4, when the vehicle 2 is present out of the communication range of the network L, the emergency report system 1 may transmit the report information to the V2V communication counterpart vehicle 2 by executing the V2V bucket-brigade process.

Next, a description will be given, with reference to FIG. 5, of control processing to be performed by the emergency report system 1 according to the present example embodiment in the vehicle 2 to receive the report information (e.g., the relay vehicle 2B to receive the report information from the abnormal vehicle 2A, or the relay vehicle 2C to receive the report information from the relay vehicle 2B in FIG. 2).

If the V2V communication is established (Step C01: YES), the communication ECU 20 may start receiving the report information and the stop request notification from the V2V communication counterpart vehicle 2 (e.g., the abnormal vehicle 2A as a V2V communication counterpart to the relay vehicle 2B, or the relay vehicle 2B as a V2V communication counterpart to the relay vehicle 2C in FIG. 2) (Step C02). When the communication ECU 20 receives the stop request notification, the notification ECU 50 may notify the driver who drives the vehicle 2 of the reception of the stop request notification, to thereby urge the driver to stop the vehicle 2 (Step C03). The notification in Step C03 may be issued by displaying the notification on the display 511, outputting the notification in the form of a sound from the speaker 512, or both.

After the notification is issued to urge the driver who drives the vehicle 2 to stop the vehicle 2, the emergency report ECU 10 may determine whether the vehicle 2 is stoppable (Step C04). In the determination in Step C04, it may be determined whether the driver urged to stop the vehicle 2 by the notification in Step C3 has an intention of stopping the vehicle 2, that is, whether the vehicle 2 is stoppable. In some embodiments, the determination as to whether the vehicle 2 is stoppable may be made based on a response of the driver to the notification urging the stop of the vehicle 2, using a voice recognition functionality of the vehicle 2. If an utterance of the driver indicating that the driver has an intention of stopping the vehicle 2 is recognized, the vehicle 2 is determined to be stoppable. If an utterance of the driver indicating that the driver has no intention of stopping the vehicle 2 is recognized or if no response is recognized, the vehicle 2 is determined not to be stoppable. In some embodiments, a message asking whether the vehicle 2 is stoppable may be displayed on the CID, and it may be determined whether the vehicle 2 is stoppable, based on an operation made by the driver on the CID.

In some embodiments, the determination as to whether the vehicle 2 is stoppable may be made based on the traveling information on the vehicle 2 acquired from the driving ECU 40 via the in-vehicle network 4. For example, in a case where the traveling information indicating that an operation on the accelerator pedal has been reduced (i.e., the vehicle speed has been decreased) or the brake pedal has been operated is acquired within a predetermined period of time after the notification to the driver in Step C03, the vehicle 2 may be determined to be stoppable. If the traveling information indicating that the operation on the accelerator pedal has remained the same (i.e., the vehicle speed has remained the same) or the accelerator pedal has been further depressed (i.e., the vehicle speed has been increased) within a predetermined period of time after the notification to the driver after Step C03, the vehicle 2 may be determined not to be stoppable.

If the determination in Step C04 is to be made while the vehicle 2 is traveling in an automated driving mode, an AI device for the automated driving may automatically determine whether the vehicle 2 is stoppable. In some embodiments, an unillustrated sensor that detects a surrounding environment of the vehicle 2 may acquire the traveling information on the vehicle 2 as to whether another vehicle is present around the vehicle 2 (e.g., whether a following vehicle is present) or whether a road on which the vehicle 2 is traveling is an expressway, and the determination as to whether the vehicle 2 is stoppable may be automatically made based on the acquired traveling information. In such embodiments, the vehicle 2 may be determined to be stoppable when no following vehicle is present or when the road on which the vehicle 2 is traveling is not an expressway. In contrast, the other vehicle 2 may be determined not to be stoppable when a following vehicle is present or when the road on which the vehicle 2 is traveling is an expressway. Note that the notification to the driver in Step C03 may not be performed when the vehicle 2 is traveling in the automated driving mode.

In some embodiments, the determination in Step C04 may be performed based on a coupling strength of an electric communication wave from the V2V communicator 213. In the V2V communication, the coupling strength of the electric communication wave may decrease as the distance between the vehicles increases. Accordingly, in the determination in Step C04, the vehicle 2 may be determined to be stoppable when the coupling strength of the electric communication wave from the V2V communicator 213 does not become less than or equal to a threshold within a predetermined period of time or when a rate of decrease in the coupling strength of the electric communication wave per unit time is less than or equal to a threshold. In contrast, the vehicle 2 may be determined not to be stoppable when the coupling strength of the electric communication wave from the V2V communicator 213 becomes less than or equal to the threshold within the predetermined period of time or when the rate of decrease in the coupling strength of the electric communication wave from the V2V communicator 213 per unit time is greater than the threshold.

If the vehicle 2 is determined to be stoppable, based on the criteria described above (Step C04: YES), the processing may proceed to Step C05. If the other vehicle 2 is determined not to be stoppable (Step C04: NO), the processing may proceed to Step C12.

If the vehicle 2 is determined to be stoppable (Step C04: YES), the communication ECU 20 may start vehicle stop control (Step C05), and wait until the reception of the report information is completed (Step C06). When the vehicle 2 is not traveling in the automated driving mode, the vehicle stop control may involve issuing a notification that urges the driver to stop the vehicle 2, and after the vehicle 2 is stopped, issuing a notification that urges the driver to keep the vehicle 2 stopped until the reception of the report information is completed. When the vehicle 2 is traveling in the automated driving mode, the vehicle stop control may involve automatically stopping the vehicle 2 in a place in which the vehicle 2 is allowed to stop, and keeping the vehicle 2 stopped until the reception of the report information is completed. Further, when the vehicle 2 is traveling in the automated driving mode, a notification indicating that the vehicle 2 is stopping to receive the report information may be issued to the occupant. The vehicle stop control may continue until the reception of the report information is completed (Step C06: NO).

If the reception of the report information has been completed (Step C06: YES), the communication ECU 20 may terminate the V2V communication, and end the vehicle stop control (Step C07). Thereafter, the communication ECU 20 may determine whether the vehicle 2 is present within the communication range of the network L (Step C08). If the vehicle 2 is present within the communication range of the network L (Step C08: YES), the communication ECU 20 may transmit the received report information from the network communicator 212 to the report center H via the network L (Step C09).

If the vehicle 2 is present out of the communication range of the network L (Step C08: NO), the communication ECU 20 may search for a V2V communication counterpart vehicle 2 that is a surrounding vehicle 2 communicable with the vehicle 2 via the V2V communication, using the V2V communicator 213 (Step C10). If the V2V communication counterpart vehicle 2 has been found (Step C10: YES), the communication ECU 20 may execute the V2V bucket-brigade process as described above with reference to FIG. 4 (Step C11), and end the series of processes.

If the vehicle 2 runs into the communication range of the network L during the search for the V2V communication counterpart vehicle 2 (Step C10: NO, and Step C08: YES), the communication ECU 20 may transmit the received report information from the network communicator 212 to the report center H via the network L (Step C09).

The description returns to Step C04. If the vehicle 2 is determined not to be stoppable in Step C04 (Step C04: NO), the communication ECU 20 may execute vehicle non-stop control (Step C12), and end the series of processes. The vehicle non-stop control will be described in detail later with reference to FIG. 6.

Next, a description will be given, with reference to FIG. 6, of the vehicle non-stop control in Step C12 of FIG. 5. The vehicle non-stop control may be executed when the vehicle 2 is determined not to be stoppable in Step C04 of FIG. 5 (Step C04: NO).

If the vehicle 2 is determined not to be stoppable (Step C04: NO), the communication ECU 20 may transmit a non-stop notification to the V2V communication counterpart vehicle 2 (e.g., the abnormal vehicle 2A as a V2V communication counterpart to the relay vehicle 2B, or the relay vehicle 2B as a V2V communication counterpart to the relay vehicle 2C in FIG. 2) (Step D01). In the V2V bucket-brigade process illustrated in FIG. 4, the determination as to whether the V2V communication counterpart vehicle 2 (e.g., the relay vehicle 2B as a V2V communication counterpart to the abnormal vehicle 2A, or the relay vehicle 2C as a V2V communication counterpart to the relay vehicle 2B in FIG. 2) is to stop in Step B03 may be made based on whether the non-stop notification transmitted in Step D01 has been received.

After transmitting the non-stop notification, the communication ECU 20 may wait until the reception of the report information is completed (Step D02). The V2V communication counterpart vehicle 2 having received the non-stop notification transmitted in Step D1 may reduce the amount of the report information to transmit (Step B04). Accordingly, in Step D02, the communication ECU 20 waits until the reception of the report information the amount of which has been reduced is completed.

If the reception of the report information has been completed (Step D02: YES), the communication ECU 20 may terminate the V2V communication (Step D03). Thereafter, the communication ECU 20 may determine whether the vehicle 2 is present within the communication range of the network L (Step D04). If the vehicle 2 is present within the communication range of the network L (Step D04: YES), the communication ECU 20 may transmit the received report information from the network communicator 212 to the report center H via the network L (Step D05).

If the vehicle 2 is present out of the communication range of the network L (Step D04: NO), the communication ECU 20 may search for a V2V communication counterpart vehicle 2 that is a surrounding vehicle 2 communicable with the vehicle 2 via the V2V communication, using the V2V communicator 213 (Step D06). If the vehicle 2 runs into the communication range of the network L during the search for the V2V communication counterpart vehicle 2 (Step D06: NO, and Step D04: YES), the communication ECU 20 may transmit the generated report information from the network communicator 212 to the report center H via the network L (Step D05).

If the V2V communication counterpart vehicle 2 has been found (Step D06: YES), the communication ECU 20 of the vehicle 2 may execute the V2V bucket-brigade process (Step D07), and end the series of processes.

If the vehicle 2 runs away out of the V2V communication range before the reception of the report information in Step D02 is completed (Step D02: NO, and Step D08: NO), the communication ECU 20 may terminate the V2V communication (Step D09), and end the series of processes.

If the vehicle 2 receiving the report information runs away out of the V2V communication range (Step D02: NO), the V2V communication counterpart vehicle 2 (the vehicle 2 transmitting the report information) may terminate the V2V communication (Step B08) because the determination in Step B07 results in NO, and thereafter execute the above-described process to be performed before the execution of the V2V bucket-brigade process. That is, even if the vehicle 2 to receive the report information is not stoppable and fails to complete the reception of the report information, the vehicle 2 to transmit the report information may return the processing to the process in Step A06, Step C10, or Step D06 to search again for a V2V communication counterpart vehicle and transmit the report information to the V2V communication counterpart vehicle.

As a result of the processing in each of the vehicles 2, which having been described above with reference to FIGS. 3 to 6, it is possible to transmit the report information generated by the abnormal vehicle 2A to the report center H.

As described in detail above with reference to the drawings, the emergency report system 1 according to the foregoing example embodiments is applicable to a vehicle configured to establish the V2V communication. The emergency report system 1 includes the processor (ECUs) and the communicator (communicator 21) configured to perform transmission and reception of the report information. The vehicle includes a first vehicle to receive the report information and a second vehicle to transmit the report information. When the communicator in the first vehicle starts receiving the report information, the processor in the first vehicle determines whether the first vehicle is stoppable. When determining that the first vehicle is stoppable, the processor in the first vehicle executes the vehicle stop control of stopping the first vehicle and keeping the first vehicle stopped until the reception of the report information is completed. This helps to facilitate the transmission and reception of the report information between vehicles. Accordingly, it is possible to improve the effectiveness of the emergency report.

Further, according to the emergency report system 1 of the foregoing example embodiments, the processor in the first vehicle may transmit the non-stop notification to the second vehicle when determining that the first vehicle is not stoppable. When receiving the non-stop notification, the processor in the second vehicle may reduce the amount of the report information to transmit. This helps to reduce the amount of the report information to transmit and complete the transmission of the report information before the first vehicle runs away out of the V2V communication range, even when the first vehicle is not stoppable. Accordingly, it is possible to improve the effectiveness of the emergency report.

After the V2V communication is terminated in Step D09, the first vehicle may record position data on a location where the reception of the report information has started, and transmit, to a third vehicle determined thereafter to be communicable with the first vehicle via the V2V communication, data indicating that the report information has been received, and the position data on the location where the reception of the report information has started. This allows another vehicle to be informed that there is a vehicle ready to transmit the report information, even when the reception of the report information fails to be completed. When receiving these pieces of data, the other vehicle such as the third vehicle may possibly travel to the location indicated by the position data. Accordingly, it is possible to improve the effectiveness of the emergency report.

Further, according to the foregoing example embodiments, the emergency report system 1 may end the series of processes when the V2V bucket-brigade process ends. However, in some embodiments, the emergency report system 1 may continue monitoring whether the vehicle is present within the communication range of the network L even after the V2V bucket-brigade process ends, and transmit the report information to the report center H upon detecting that the vehicle 2 has entered the communication range of the network L. This helps to achieve earlier transmission of the report information to the report center H.

Further, according to the foregoing example embodiments, the V2V communication may be terminated when the transmission of the report information in the V2V bucket-brigade process is completed in Step B05, and the series of processes performed by the emergency report system 1 may end. However, when the report information is to be reduced in amount in the process in Step B04, the emergency report system 1 may search again for another V2V communication counterpart vehicle 2 communicable with the vehicle 2 via the V2V communication and continue performing the processes until the reception of the report information having not been reduced in amount is completed. This helps to increase the possibility of transmission of more accurate report information to the report center H. Receiving the more accurate report information from the report center H, the emergency service facility (emergency hospital, police station, or fire station) makes it possible to perform higher-quality rescue activities.

Further, according to the foregoing example embodiments, the emergency report system 1 may further include the emergency report ECU 10 in the vehicle 2, and the emergency report ECU 10 may detect the operation of the emergency report button 11, generate the report information, and determine whether the vehicle 2 is stoppable. However, in some embodiments, the emergency report system 1 may not include the emergency report ECU 10, and may cause another ECU to detect the operation of the emergency report button 11, generate the report information, and determine whether the vehicle 2 is stoppable. That is, the emergency report system 1 may include the emergency report ECU 10 according to the present example embodiment, or may include another known ECU configured to implement the functionalities of the emergency report ECU 10.

Although some embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

The limitations in the claims are to be interpreted broadly based on the language employed in the claims and not limited to examples described in this specification or during the prosecution of the application, and the examples are to be construed as non-exclusive.

As used in this specification and the appended claims, the singular forms “a”, “an”, and “the” include, especially in the context of the claims, are to be construed to cover both the singular and the plural, unless otherwise indicated herein or clearly contradicted by context.

Throughout this specification and the appended claims, unless the context requires otherwise, the terms “comprise”, “include”, “have”, and their variations are to be construed to cover the inclusion of a stated element, integer, or step but not the exclusion of any other non-stated element, integer, or step.

The use of the terms first, second, etc. does not denote any order or importance, but rather the terms first, second, etc. are used to distinguish one element from another.

The terms “substantially” “about”, and their variants having similar meanings thereto are defined as being largely but not necessarily wholly what is specified as understood by one of ordinary skill in the art.

The terms “disposed on”, “provided on”, and its variants having similar meanings thereto as used herein refer to elements disposed directly in contact with each other or indirectly by having intervening structures therebetween.

According to the foregoing example embodiments of the disclosure, it is possible to improve the effectiveness of the emergency report by urging the relay vehicle to keep stopping while the report information is transmitted to the relay vehicle via the V2V communication and issuing the emergency report via the relay vehicle.

The ECUs and the communicator 21 illustrated in FIG. 1 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the ECUs and the communicator 21 illustrated in FIG. 1. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the ECUs and the communicator 21 illustrated in FIG. 1.

1. An emergency report system to be applied to a vehicle configured to establish vehicle-to-vehicle communication, the emergency report system comprising:
a processor; and
a communicator configured to perform transmission and reception of report information, wherein
the vehicle comprises a first vehicle configured to receive the report information, and
the processor in the first vehicle is configured to,
when the communicator in the first vehicle starts receiving the report information, determine whether the first vehicle is stoppable, and
when determining that the first vehicle is stoppable, execute vehicle stop control of stopping the first vehicle and keeping the first vehicle stopped until the reception of the report information is completed.

2. The emergency report system according to claim 1, wherein
the processor in the first vehicle is configured to,
when the first vehicle is traveling in an automated driving mode, execute the vehicle stop control of automatically stop the first vehicle in a place where the first vehicle is allowed to stop and keeping the first vehicle stopped until the reception of the report information is completed, and
when the first vehicle is not traveling in the automated driving mode, execute the vehicle stop control of issuing a notification that urges a driver who drives the first vehicle to stop the first vehicle and issuing a notification that urges the driver to keep the first vehicle stopped until the reception of the report information is completed.

3. The emergency report system according to claim 1, wherein
the vehicle comprises a second vehicle configured to transmit the report information,
the processor in the first vehicle is configured to, when determining that the first vehicle is not stoppable, transmit a non-stop notification to the second vehicle, and
the processor in the second vehicle is configured to, when receiving the non-stop notification, reduce an amount of the report information to transmit.

4. The emergency report system according to claim 2, wherein
the vehicle comprises a second vehicle configured to transmit the report information,
the processor in the first vehicle is configured to, when determining that the first vehicle is not stoppable, transmit a non-stop notification to the second vehicle, and
the processor in the second vehicle is configured to, when receiving the non-stop notification, reduce an amount of the report information to transmit.

5. The emergency report system according to claim 1, wherein the processor in the first vehicle is configured to, when the vehicle-to-vehicle communication is terminated before the reception of the report information is completed, transmit position data on a location where the reception of the report information has started, to a third vehicle determined thereafter to be communicable with the first vehicle via the vehicle-to-vehicle communication.

6. The emergency report system according to claim 2, wherein the processor in the first vehicle is configured to, when the vehicle-to-vehicle communication is terminated before the reception of the report information is completed, transmit position data on a location where the reception of the report information has started, to a third vehicle determined thereafter to be communicable with the first vehicle via the vehicle-to-vehicle communication.

7. A vehicle comprising the emergency report system according to claim 1.

8. A vehicle comprising the emergency report system according to claim 2.
